(19) United States
(12) Patent Application Publication
(10) Pub. No.: US 2022/0274613 A1
(43) Pub. Date: Sep. 1, 2022

(54) Methods and Apparatus for Activating and Monitoring Functions of an Autonomous Vehicle

(71) Applicant: Nuro, Inc., Mountain View, CA (US)

(72) Inventors: Paul Michael White, Mountain View, CA (US); Grant Yuan Emmendorfer, San Jose, CA (US)

(73) Assignee: Nuro, Inc., Mountain View, CA (US)

(21) Appl. No.: 17/631,840

(22) PCT Filed: Oct. 29, 2020
(86) PCT No.: PCT/US2020/057990

§ 371 Date: Jan. 31, 2022

Related U.S. Application Data
(60) Provisional application No. 62/930,093, filed on Nov. 4, 2019.
(60) Provisional application No. 62/930,373, filed on Nov. 4, 2019.

(51) Int. Cl. B60W 50/08; B60K 37/06; B60W 60/00; B60W 30/14

(52) U.S. Cl. CPC B60W 50/082; B60K 37/06; B60W 60/0054; B60W 30/143; B60W 2420/54; B60K 2310/20; B60W 2540/215

(57) ABSTRACT

According to one aspect, mechanisms already in vehicles may be substantially repurposed or reconfigured to facilitate autonomous driving. Cruise control controls, e.g, a cruise control stem or stick, in a vehicle may be configured for use to activate and to deactivate an autonomous mode in the vehicle. By repurposing cruise control controls to activate and to deactivate an autonomous mode, drivers may efficiently activate and deactivate the autonomous mode while a vehicle operates, a vehicle includes an autonomy system, an activator mechanism, and a cruise control system. The autonomy system is configured to enable the vehicle to operate in an autonomous mode when the autonomy system is in an active state. The activator mechanism including a toggle having a first toggle state and a second toggle state. The toggle is in communication with the autonomy system to activate the active state when the toggle is in the first toggle state and to deactivate the active state when the toggle is in the second toggle state The cruise control system is arranged to be engaged to cause a speed of the vehicle to be automatically controlled, wherein the cruise control system is physically decoupled from the activator mechanism.

### CROSS-REFERENCE TO RELATED APPLICATIONS

This PCT patent application claims priority to U.S. Provisional Patent Application No. 62/930,093, filed Nov. 4, 2019, and U.S. Provisional Patent Application No. 62/930,373, filed Nov. 4, 2019, the contents of each which are incorporated herein by reference it their entireties.

### TECHNICAL FIELD

The disclosure relates generally to autonomous vehicles. More particularly, the disclosure relates to activating and deactivating functions of an autonomous vehicle.

### BACKGROUND

Most vehicles, such as cars and trucks, generally have the same, or standard, components for use by a driver. For example, most vehicles include a steering wheel and various mechanisms which are near or on the steering wheel. The various mechanisms typically include a directional or “turning signal” lever, a windshield wiper lever, and a cruise control lever.

Standard components used by a driver of a vehicle are universal, and are well-understood. The addition of new, or non-standard, components that a driver must learn to use may lead to confusion as the driver becomes familiar with the new components. Such confusion may be a safety hazard if a driver loses focus while driving as he/she attempts to use the new components.

### SUMMARY

In one embodiment, mechanisms already in vehicles may be substantially repurposed or reconfigured to facilitate autonomous driving. Cruise control controls, e.g., a cruise control stem or stick, in a vehicle may be configured for use to activate and to deactivate an autonomous mode in the vehicle. By repurposing cruise control controls to activate and to deactivate an autonomous mode, drivers may efficiently activate and deactivate the autonomous mode.

In another embodiment, a vehicle includes an autonomy system, an activator mechanism, and a cruise control system. The autonomy system is configured to enable the vehicle to operate in an autonomous mode when the autonomy system is in an active state. The activator mechanism including a toggle having a first toggle state and a second toggle state. The toggle is in communication with the autonomy system to activate the active state when the toggle is in the first toggle state and to deactivate the active state when the toggle is in the second toggle state The cruise control system is arranged to be engaged to cause a speed of the vehicle to be automatically controlled, wherein the cruise control system is physically decoupled from the activator mechanism.

In still another embodiment, an autonomous vehicle that includes a drive-by-wire (DBW) system also includes a DBW notification component or unit that provides vehicle operators or drives with information relating to the current state of the DBW system. The DBW notification component may include a display screen and a speaker to provide visual and audio feedback, respectively, such that a vehicle operator may understand the state of the DBW system. Such a DBW notification component may communicate with the DBW system either wirelessly or over wired communications.

In yet another embodiment, a method of controlling a vehicle that has at least a first mode of operation and a second mode of operation includes operating the vehicle in the first mode of operation, determining when a mode change is indicated using a toggle of an activator mechanism, wherein determining when the mode change is indicated using the toggle includes obtaining a first signal at an autonomy system of the vehicle from the activator mechanism through an interface, the interface configured to communicably connect the activator mechanism to the autonomy system and to disconnect the activator mechanism from a cruise control system of the vehicle. When the mode change is indicated, the method includes operating the vehicle in the second mode of operation using the autonomy system.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle in accordance with an embodiment.

FIG. 2A is a diagrammatic representation of one example of a vehicle which may be configured to operate autonomously in accordance with an embodiment.

FIG. 2B is a diagrammatic representation of another example of a vehicle which may be configured to operate autonomously in accordance with an embodiment.

FIG. 3 is a block diagram representation of an autonomous vehicle in accordance with an embodiment.

FIG. 4A is a diagrammatic representation of a first steering wheel assembly with cruise control controls and a microphone controller in accordance with an embodiment.

FIG. 4B is a diagrammatic representation of a second steering wheel assembly with cruise control controls and a microphone controller in accordance with an embodiment.

FIG. 5 is a block diagram representation of a first system in which functions of physical components in a vehicle are reassigned in accordance with an embodiment.

FIG. 6A is a block diagram representation of a second system in which functions of physical components in a vehicle are reassigned in accordance with an embodiment.

FIG. 6B is a block diagram representation of an interface system, e.g., interface system 678 of FIG. 6A, in accordance with an embodiment.

FIGS. 7A and 7B are a process flow diagram which illustrates one method of operating a vehicle in which cruise control controls are utilized to activate and to deactivate an autonomous mode in accordance with an embodiment.

FIG. 8 is a process flow diagram which illustrates one method of operating a recording functionality of a vehicle utilizing microphone controls in accordance with an embodiment.

FIG. 9 is a block diagram representation of how multiple control arrangements of cruise control controls may be assigned for use to control an autonomy system in accordance with an embodiment.

FIG. 10 is a diagrammatic representation of an autonomous vehicle with a drive-by-wire (DBW) system and a DBW notification component in accordance with an embodiment.

FIG. 11 is a block diagram representation of a DBW notification component in accordance with an embodiment.

FIG. 12 is a diagrammatic representation of a dashboard of a vehicle on which a DBW notification component is installed in accordance with an embodiment.

FIG. 13 is a process flow diagram which illustrates a method of operating a DBW notification component in accordance with an embodiment.

### DESCRIPTION OF EXAMPLE EMBODIMENTS

The same general components have been used in vehicles for many decades for the same purposes. That is, controls and mechanisms in vehicles have been substantially standardized. As a result, drivers have been conditioned to expect certain mechanisms to be located in certain places within a vehicle, and to expect those mechanisms to perform particular functions. For example, drivers of left-hand drive vehicles expect a turn signal to be on the left side of a steering wheel, and expect that triggering the turn signal in a clockwise direction activates a right turn signal while triggering the turn signal in a counter-clockwise direction activates a left turn signal.

With autonomous vehicles, the need for additional controls and mechanisms arises because functionalities of autonomous vehicles generally need to be trigger, e.g., activated, and deactivated. By repurposing some controls or mechanisms in a vehicle, e.g., lesser-used controls or controls that are unlikely to be used when the vehicle is operating autonomously, a proliferation of additional controls or mechanisms in a vehicle may be avoided. Further, repurposing lesser-used controls or controls that are unlikely to be used for purposes related to autonomous driving allows a driver or a user to readily access the controls without searching for new controls while driving.

In one embodiment, cruise control controls in a vehicle may be repurposed or otherwise reconfigured to activate autonomous mode. For example, a cruise control stem, stick, or lever may be reconfigured such that instead of being used to turn on and off cruise control functionality, the cruise control stem, stick, or lever may instead be used to turn on and off autonomous mode. In other words, cruise control controls that may be used by a driver to engage and to disengage a cruise control system to substantially automatically control the speed of a vehicle may be disconnected from the cruise control system and effectively repurposed for use in engaging and disengaging an autonomous or self-driving mode in the vehicle. As cruise control controls are typically, in the vicinity of a steering wheel of a vehicle, the cruise control controls may be readily accessed by a vehicle operator.

In another embodiment, in order to collect data when a vehicle is operating in autonomous mode, microphone controls in the vehicle may be used to activate a recording function that allows a vehicle operator. The collection of data when a vehicle is in autonomous mode may be critical, for example, to allow issues with autonomous software to be identified. By allowing microphone controls, such as microphone controls located on a steeling wheel in a vehicle, to trigger a recording feature by initiating a recording mode and terminating a recording mode, a vehicle operator may verbally describe a situation which may be accessed at a later time and correlated with any data that is collected by the vehicle. Such a recorded description of a situation may facilitate the identification of anomalies in data when the recorded description is correlated with the data.

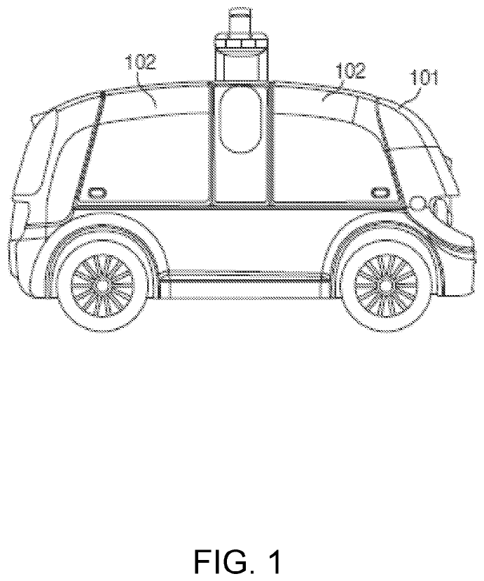

FIG. 1 is a diagrammatic representation of a side of an autonomous vehicle in accordance with an embodiment. An autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 is generally arranged to transport and/or to deliver cargo, items, and/or goods, and may be included in a fleet of vehicles. Autonomous vehicle 101 may be fully autonomous and/or semi-autonomous. In general, autonomous vehicle 101 may be a vehicle that is capable of travelling in a controlled manner for a period of time without intervention, e.g., without human intervention.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

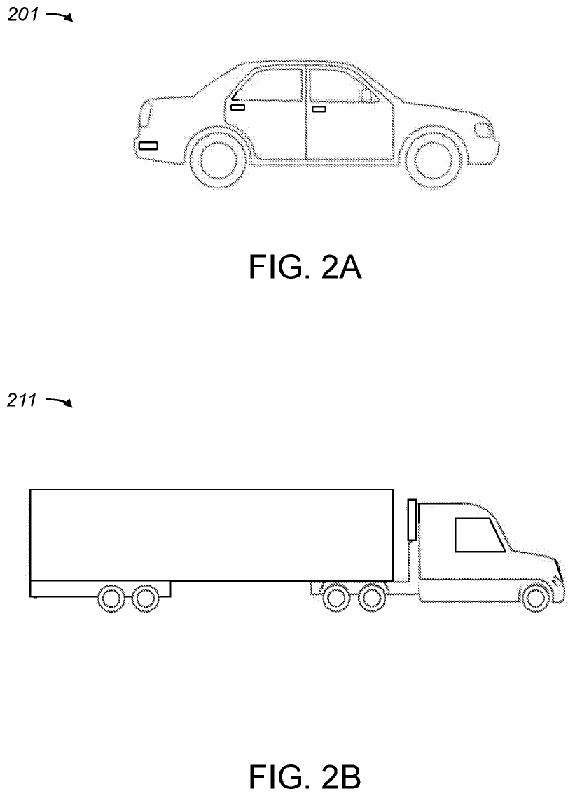

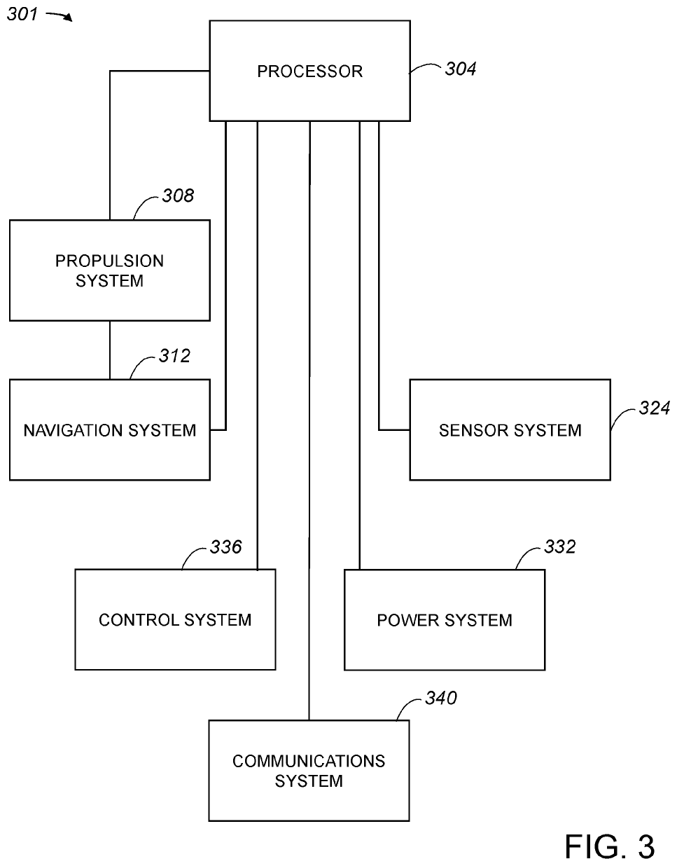

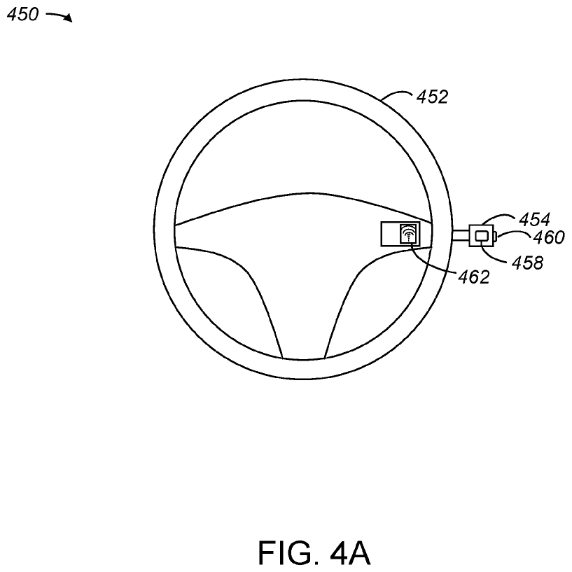

Although autonomous vehicle 101 is an autonomous vehicle that does not accommodate a driver or passengers, many vehicles capable of operating autonomously, e.g., fully autonomously or semi-autonomously, may accommodate a driver as well as passengers. FIGS. 2A and 2B are diagrammatic representations of vehicles which may be driven by a driver, e.g., a human driver or a safety driver, and configured to operate in an autonomous mode. As shown in FIG. 2A, in one embodiment, a car 201 may be operated by a driver and also configured to operate autonomously. Configuring car 201 to operate autonomously may include, but is not limited to including, outfitting car 201 with sensors and autonomy software, as will be discussed below with respect to FIG. 3. As shown in FIG. 2B, in another embodiment, a truck 211 may be operated by a driver and also configured to operate autonomously. Similar to car 201 of FIG. 2A, truck 211 of FIG. 2B may be outfitted with sensors and autonomy software.

Autonomous vehicle 101 of FIG. 1, autonomous vehicle 201 of FIG. 2A, and autonomous vehicle 211 of FIG. 2B may include similar components, e.g., each of the vehicles may include systems which allow the vehicles to operate substantially autonomously. FIG. 3 is a block diagram representation of an autonomous vehicle, in accordance with an embodiment. An autonomous vehicle 301 may generally be any suitable vehicle including, but not limited to including, autonomous robotic vehicle 101 of FIG. 1, car 201 of FIG. 2A, or truck 211 of FIG. 2B. Autonomous vehicle 301 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 301.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 301 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine. The propulsion engine may be at least partially controlled by an accelerator which controls an amount of fuel and/or electrical power to be provided.

It should be appreciated that although one processor 304 is shown in FIG. 3, any number of processors may be implemented in autonomous vehicle 301. In other words, one or more processors 304 may generally be used within autonomous vehicle 301.

Navigation system 312 may control propulsion system 308 to navigate autonomous vehicle 301 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 301 to navigate through an environment.

Sensor system 324 includes any sensors, as for example lidar, radar, ultrasonic sensors, microphones, altimeters, and/or cameras. Sensor system 324 generally includes onboard sensors which allow autonomous vehicle 301 to safely navigate, and to ascertain when there are objects near autonomous vehicle 301. In one embodiment, sensor system 324 may include propulsion systems sensors that monitor drive mechanism performance, drive train performance, and/or power system levels.

Power system 332 is arranged to provide power to autonomous vehicle 301. Power may be provided as electrical power, gas power, or any other suitable power, e.g., solar power or battery power. In one embodiment, power system 332 may include a main power source, and an auxiliary power source that may serve to power various components of autonomous vehicle 301 and/or to generally provide power to autonomous vehicle 301 when the main power source does not does not have the capacity to provide sufficient power.

Communications system 340 allows autonomous vehicle 301 to communicate, as for example, wirelessly, with a fleet management system (not shown) that allows autonomous vehicle 301 to be controlled remotely. Communications system 340 generally obtains or receives data, stores the data, and transmits or provides the data to a fleet management system and/or to multiple autonomous vehicles 301 that are part of a fleet of autonomous vehicles. The data may include, but is not limited to including, information relating to scheduled requests or orders, information relating to on-demand requests or orders, and/or information relating to a need for autonomous vehicle 301 to reposition itself, e.g., in response to an anticipated demand.

In some embodiments, control system 336 may cooperate with processor 304 to determine where autonomous vehicle 301 may safely travel, and to determine the presence of objects in a vicinity around autonomous vehicle 301 based on data, e.g., results, from the sensor system 324. In other words, control system 336 may cooperate with processor 304 to effectively determine what autonomous vehicle 301 may do within its immediate surroundings. Control system 336 in cooperation with processor 304 may essentially control power system 332 and navigation system 312 as part of driving or conveying autonomous vehicle 301. Additionally, control system 336 may cooperate with processor 304 and communications system 340 to provide data to or obtain data from other autonomous vehicles 301, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 301 to operate autonomously. In one embodiment, autonomy software that allows vehicle 301 to operate autonomously may operate with respect to control system 336, propulsion system 308, navigation system 312, sensor system 324, and power system 332.

In one embodiment, cruise control controls may be reconfigured such that the cruise control controls may be used to effectively trigger autonomy software to cause vehicle 301 to operate in autonomous mode. That is, cruise control controls may be used to cause control system 336 to cooperate at least with processor 304, propulsion system 308, navigation system 312, sensor system 324, and power system 332 to allow vehicle 301 to operate autonomously. It should be appreciated that the cruise control controls may also be used to cause vehicle 301 to switch from operating in autonomous mode to operating in a non-autonomous mode.

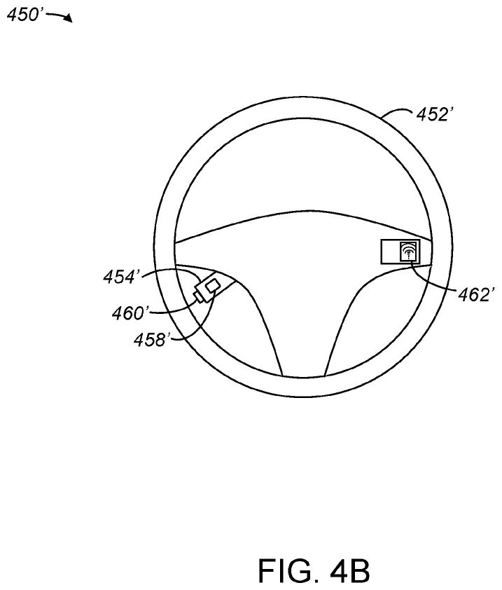

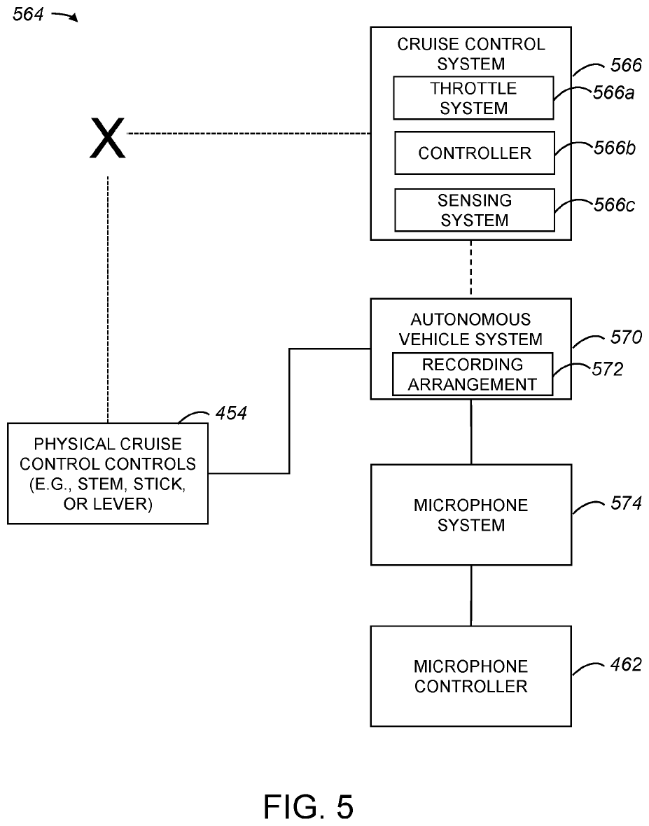

With reference to FIG. 4A, a first steering wheel assembly with cruise control controls and a microphone controller will be described in accordance with an embodiment. As mentioned above, in one embodiment, cruise control controls may be used to activate and to deactivate an autonomous mode for a vehicle, and microphone controls may be used to activate and to deactivate a recording mode. A steering wheel assembly 450 includes a steering wheel 452 which is generally part of a propulsion system of a vehicle. Steering wheel assembly 450 also includes cruise control controls or a cruise control activator mechanism 454. It should be appreciated that steering wheel assembly 450 generally includes many other controls and mechanisms, e.g., a turn indicator stem and wiper controls, which have not been shown for ease of illustration.

Cruise control controls 454 may include a button or switch 458 that may be configured, in one embodiment, to activate an autonomous mode and to deactivate an autonomous mode. For example, when a vehicle is operating in a non-autonomous mode, engaging button or switch 458 may cause an autonomous mode to be activated. On the other hand, when a vehicle is operating in an autonomous mode, engaging button or switch 458 may cause the autonomous mode to be deactivated. In one embodiment, cruise control controls 454 may be a mechanical arrangement mounted on, or configured as, a lever or a bar, e.g., a handlebar. Cruise control controls 454 may generally include other activating mechanisms, e.g., buttons or switches, in addition to button or switch 458. For example, a button 460 may be arranged to be actuated to add a flag or an indicator to a log to alert a reviewer of the log to note data that is flagged by the flag. It should be appreciated that such a log generally includes information relating to the operations of a vehicle, e.g., autonomous operations of the vehicle.

Steering wheel 452 includes a microphone controller 462. Microphone controller 462 may generally be a button or a switch which may be engaged, e.g., pressed or flipped, to effectively turn a microphone on or off. In one embodiment, activating a microphone using microphone controller 462 activates a recording arrangement which allows sounds to be recorded. For example, a vehicle operator may effectively turn on a microphone and, thus, initiate a recording using microphone controller 462 such that the vehicle operator may record his or her thoughts while a vehicle is operating autonomously.

It should be appreciated that the configuration of cruise control controls may vary widely. For example, rather than being configured as a bar such as a cruise control handlebar that includes a switch as shown in FIG. 4A, cruise control controls may be configured as any suitable mechanism that includes a switch. FIG. 4B is a diagrammatic representation of a second steering wheel assembly with cruise control controls and a microphone controller in accordance with an embodiment. A steering wheel assembly 450′ includes a steering wheel 452′ and cruise control controls 454′.

Cruise control controls 454 may be configured as a stem or a mechanism which includes a button or switch 458′, or a first actuating mechanism, that may be configured, in one embodiment, to activate an autonomous mode and to deactivate an autonomous mode. Cruise control controls 454 may also include a button or switch 460′, or a second actuating mechanism, that may be configured to add a flag to a log with information pertaining to the operation of a vehicle, e.g., in autonomous mode. As shown, cruise control controls 454 are a mechanism that is substantially attached to either a steering wheel column (not shown) or a steering wheel 452′ that are part of steering wheel assembly 450′.

Steering wheel 452′ also includes a microphone controller 462′. Microphone controller 462′ may be actuated to effectively turn a microphone on or off to substantially record sounds heard in a vehicle, e.g., a vehicle operator or driver speaking.

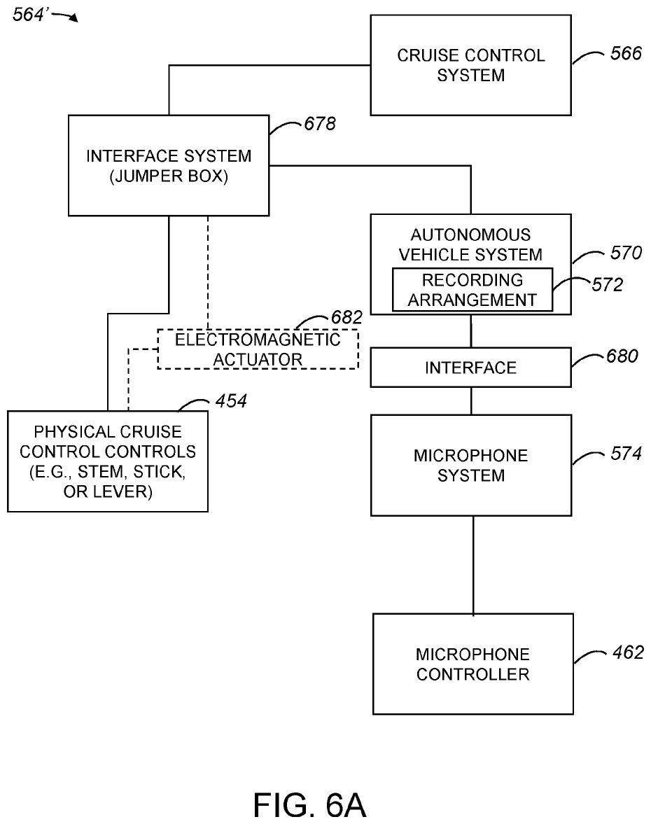

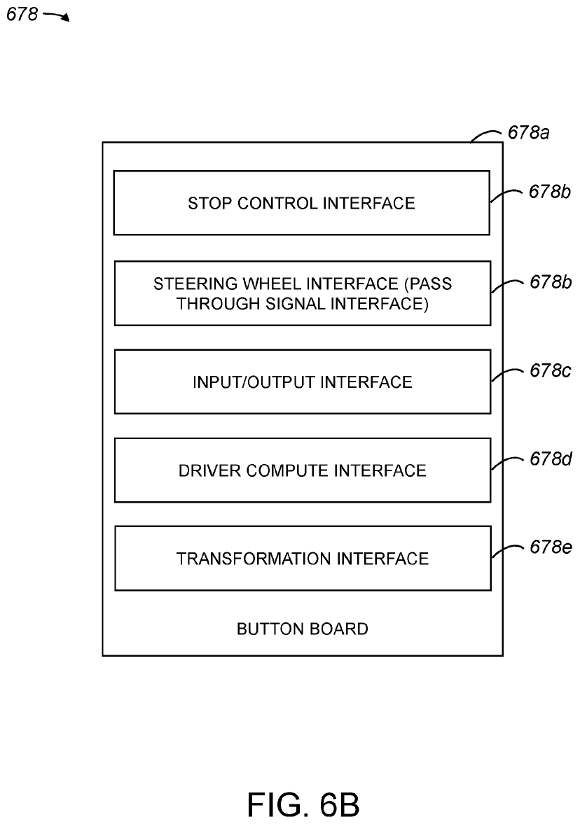

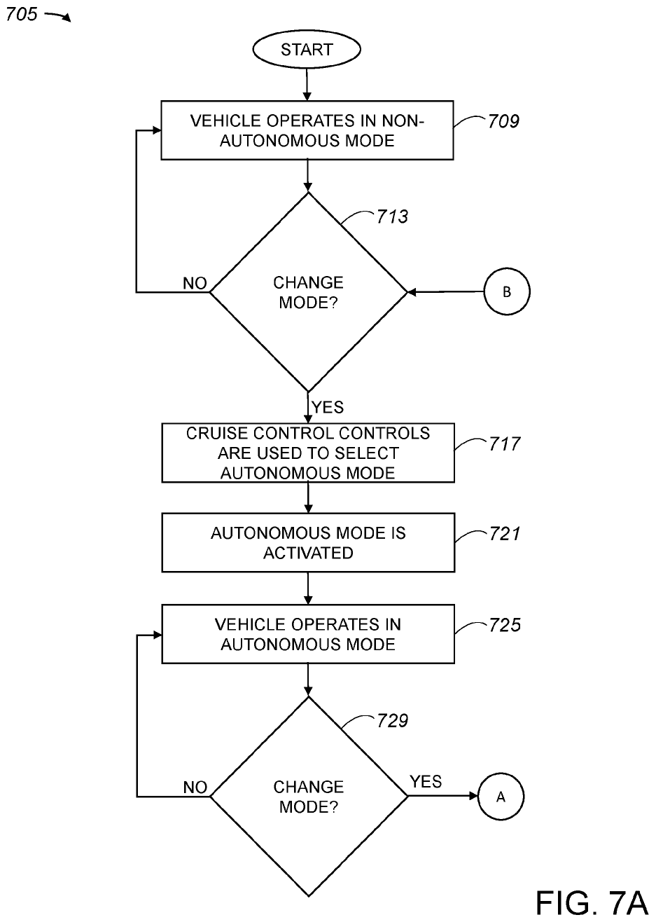

Referring next to FIGS. 5 and 6A, systems in which cruise control controls are configured to activate and deactivate autonomous operation of a vehicle, and in which a microphone controller may be used to initiate and terminate a recording, will be described in accordance with embodiments. FIG. 5 is a block diagram representation of a first system in which at least one function of physical components in a vehicle are reassigned in accordance with an embodiment. A system 564 includes a cruise control system 566 which is generally designed to be activated using physical cruise control controls or cruise control activator mechanism 454. In one embodiment, cruise control controls 454 may be wired to or otherwise coupled to an autonomous vehicle system 570, rather than to cruise control system 566, in order to enable cruise control controls 454 to essentially signal autonomous vehicle system 570 to engage and/or to disengage. It should be appreciated that in such an embodiment, cruise control controls 454 may effectively be disconnected from cruise control system 566 and, instead, connected to autonomous vehicle system 570. As previously mentioned, cruise control controls 454 may be configured as a stem, switch, lever, bar, or any other suitable mechanism. In general, system 564 may be implemented within a vehicle such as vehicle 201 of FIG. 2A, vehicle 211 of FIG. 2B, and/or vehicle 301 of FIG. 3.

Cruise control system 566 is generally configured to control the speed of a vehicle, as well as to maintain a desired speed of the vehicle. Typically, cruise control system 566 effectively controls the speed of a vehicle by substantially adjusting a position of an accelerator, and maintains a desired speed by maintaining a position of the accelerator as appropriate. Cruise control system 566 may include a throttle system 566a, a controller 566b, and a sensing system 566c. Throttle system 566a may include a throttle and an actuator that is arranged to cause the throttle to open and to close such that flow of fuel or electrical power to a propulsion system may be substantially controlled. Controller 566b may generally control throttle system 566a. In one embodiment, when cruise control controls 454 are substantially disconnected from cruise control system 566, cruise control controls 454 may effectively be communicably disconnected from controller 566b. In another embodiment, cruise control controls 454 may remain connected to cruise control system 566 while cruise control system 566 is monitored to ascertain what position cruise control controls 454 are in. For example, when a cruise control activator or stick of cruse control controller 566b is detected to be in a position indicative of autonomous operation of the vehicle, alternative commands that effectively bypass all other commands other than those associated with braking and steering may be injected or otherwise recognized. Sensing system 566c includes speed sensors which are configured to measure or to otherwise monitor the speed at which a vehicle is moving, and to communicate with controller 566b such that throttle system 566a may be adjusted as appropriate to achieve a desired velocity for the vehicle.

System 564 also includes autonomous vehicle system or autonomy system 570, as mentioned above, which is arranged to enable a vehicle to operate autonomously. Autonomous vehicle system 570 is arranged, in the described embodiment, to be activated and deactivated using cruise control controls 454, as cruise control controls 454 are substantially disconnected from cruise control system 566 and connected to autonomous vehicle system 570.

Autonomous vehicle system 570 may optionally be in communication with cruise control system 566. Autonomous vehicle system 570 may include at least some systems and/or modules described above with respect to FIG. 3. Autonomous vehicle system 570, which may include software and sensors, may also include a recording arrangement 572 that facilitates the recording of sounds, e.g., voices, through a microphone system 574 and the storage of the recording. It should be appreciated that the recording may be stored within first system 564 or may be stored remotely.

Microphone system 574 generally includes at least one microphone. In many vehicles, microphone system 574 may be utilized to record audio, or voice, commands and to activate different features of the vehicle. For example, microphone system 574 generally includes at least one microphone, and may be used to program a navigation system (not shown), to select channels on a radio (not shown), to program a climate control system (not shown), etc. Microphone controller 462 may be used to activate microphone system 574 such that microphone system 574 begins to receive audio commands.

As shown, cruise control controls 454, which may be configured as a mechanical system, are not communicably connected to cruise control system 566 and are, instead, communicably connected to autonomous vehicle system 570. That is, connections between cruise control controls 454 may be disconnected such that cruise control controls 454 may not be used to substantially directly activate and/or deactivate cruise control system 566. The connection between cruise control controls 454 and autonomous vehicle system 570 may be physical, e.g., wired, or wireless. One method of allowing cruise control system 566 to be substantially disconnected from cruise control controls 454 while allowing autonomous vehicle system 570 to be substantially connected to cruise control controls 454 will be discussed below with reference to FIG. 6A.

It should be appreciated that once cruise control system 566 is effectively disconnected from cruise control controls 454, cruise control system 566 may be physically removed from system 564, or measures may be taken to substantially ensure that cruise control system 566 does not accidentally engage. Such measures may include, but are not limited to including, grounding connections associated with cruise control system 566 and/or removing connections that provide power to cruise control system 566. Alternatively, in one embodiment, functions of cruise control system 566 may be arranged to be used by autonomous vehicle system 570 to facilitate the operation of a vehicle using a drive-by-wire (DBW) system. In such an embodiment, a substantially direct physical connection between cruise control system 566 and cruise control controls 454 may be eliminated, but cruise control system 566 may either be substantially directly connected to autonomous vehicle system 570, or indirectly connected to autonomous vehicle system 570 through an interface system as will be described below with respect to FIG. 6A.

FIG. 6A is a block diagram representation of a system that includes an interface between cruise control controls and both a cruise control system and an autonomous vehicle system, as well as an interface between a microphone system and the autonomous vehicle system, in accordance with an embodiment. A system 564′ includes cruise control controls 454, microphone controller 462, cruise control system 566, autonomous vehicle system 570 with recording arrangement 572, and microphone system 574.

An interface system 678 is arranged between cruise control controls 454 and both cruise control system 566 and autonomous vehicle system 570. Interface system 678, which may be a jumper box, is configured to enable cruise control controls 454 to be communicably connected to autonomous vehicle system 570 such that autonomous vehicle system 570 may effectively intercept signals or commands sent by cruise control controls 454. In one embodiment, interface system 678 may serve to prevent signals or commands provided by cruise control controls 454 from substantially directly reaching cruise control system 566. That is, interface system 678 may reroute signals from cruise control controls 454 such that the signals are received, or otherwise obtained, by autonomous vehicle system 570 rather than by cruise control system 566.

Interface system 678 may include mechanical, electrical, and/or software components which are configured to effectively cause signals obtained using cruise control controls 454 to be provided to autonomous vehicle system 570 rather than to cruise control system 566. Interface system 678 will be discussed in more detail below with respect to FIG. 6B. In one embodiment, interface system 678 may be configured to enable autonomous vehicle system 570 to communicate with cruise control system 566. That is, interface system 678 may enable autonomous vehicle system 570 to utilize some of the functionality associated with cruise control system 566.

An interface 680, which may be a hardware and/or software interface, may be arranged to allow autonomous vehicle system 570 to be accessed by microphone system 574 at least when autonomous vehicle system 570 is operating in an autonomous mode. That is, interface 680 is configured to effectively communicably connect microphone system 574 and autonomous vehicle system 570. Interface 680 may obtain audio signals through microphone system 574. The audio signals obtained by interface 680 are provided to recording arrangement 572 which may record and store the audio signals. Activating microphone controller 462 generally causes a microphone system 574 to be activated and also causes recording arrangement 572 to record and to store audio signals.

In one embodiment, system 564′ may include an optional electromechanical actuator 682 that is arranged to effectively provide haptic feedback to physical cruise control controls 454. For example, if autonomous vehicle system 570 disengages, a signal may be sent to electromagnetic actuator 682 to cause electromagnetic actuator 682 reset a button or a switch, Electromagnetic actuator 682 may also create at least one physical movement of physical cruise control controls 454 to effectively provide an indication that autonomous vehicle system 570 has disengaged.

With reference to FIG. 6B, one embodiment of interface system 678 will be described. Interface system 678 may generally includes a button board 678a which may be printed circuit board (PCB). Button board 678a may include a stop control interface 678b, a steering wheel interface 678b, an input/output interface 678c, a driver compute interface 678d, and a transformation interface. Stop control interface 678b is configured to provide an interface between stopping mechanisms, e.g., a DBW emergency stop mechanism or a high voltage emergency stop mechanism, and a braking arrangement of a vehicle. Steering wheel interface 678b may provide an interface between a steering wheel connector and other vehicle systems that enable signals or function activated by a steering wheel to be provided as output from button board 678a. For example, horn signals, turn signals, cruise control signals, and other substantially pass-through signals may be provided by steering wheel interface 678b to button board 678a which may then provide an associated output. Input/output interface 678c may provide signals from button board 678a to systems including, but not limited to including, a high voltage junction box and a DBW arrangement. Driver compute interface 678d is arranged to enable button board 678a to effectively communicate with a driver compute arrangement of a vehicle.

Transformation interface 678e may generally cooperate with input/output interface 678c and steering wheel interface 678b to obtain a signal from physical cruise control controls, as for example physical cruise control controls 454 of FIG. 6A, and cause the signal to effectively be provided to an autonomous vehicle system such as autonomous vehicle system 570 of FIG. 6A rather than to a cruise control system such as cruise control system 566 of FIG. 6A. In other words, transformation interface 678e may effectively cause signals from physical cruise control controls to be routed to an autonomous vehicle system and not to a cruise control system.

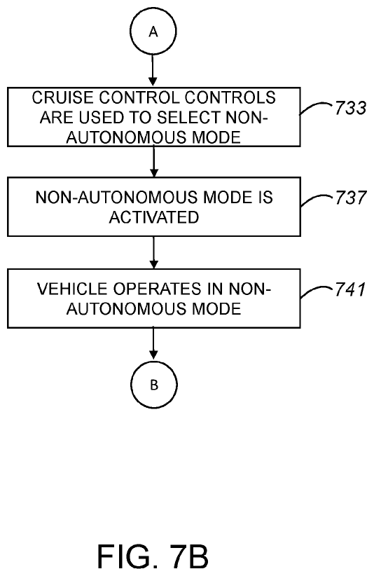

FIGS. 7A and 7B are a process flow diagram which illustrates one method of operating a vehicle in which cruise control controls are utilized to activate and to deactivate an autonomous mode in accordance with an embodiment. A method 705 of operating a vehicle with physical cruise control controls arranged to activate and deactivate an autonomous mode, rather than arranged to engage and disengage cruise control, begins at a step 709 in which a vehicle operates in a non-autonomous mode. The non-autonomous mode may, in general, be a mode in which a human driver operates the vehicle.

A determination is made in a step 713 as to whether the mode of operation of the vehicle is to change. In other words, it is determined if the driver of the vehicle plans to change from driving in a non-autonomous mode to driving in an autonomous mode. If the determination is that a change in the mode of operation is not desired, the vehicle continues to operate in a non-autonomous mode in step 709.

Alternatively, if it is determined in step 713 that the mode of operation is to change, the implication is that the mode is to be changed to an autonomous mode. Accordingly, process flow moves from step 713 to a step 717 in which cruise control controls are used to select an autonomous mode. In one embodiment, the cruise control controls may be actuated or otherwise engaged to select the autonomous mode. As mentioned above, the cruise control controls are effectively disconnected from a cruise control system and are substantially connected to an autonomous vehicle system or an autonomy system such that the cruise control controls may be used to activate and to deactivate an autonomous mode. Actuating the cruise control controls may include, but is not limited to including, pressing or pulling a lever included in the cruise control controls, pressing a button included in the cruise control controls, flipping a switch included in the cruise control controls, and/or turning a knob included in the cruise control controls.

Once the cruise control controls are used to select an autonomous mode, the autonomous mode is activated in a step 721. In other words, the vehicle is switched from operating in a non-autonomous mode to operating in an autonomous mode. In a step 725, the vehicle operates in the autonomous mode. Operating the vehicle in autonomous mode may include, in one embodiment, an autonomous vehicle system signaling a cruise control system to substantially control a propulsion system of the autonomy system. That is, the autonomous vehicle system may use functionality of the cruise control system to enable the vehicle to operate under autonomy or in an autonomous mode.

A determination is made in a step 729 as to whether the vehicle is to change from operating in the autonomous mode to operating in a non-autonomous mode. If it is determined that the mode is not to be changed, the vehicle continues to operate in the autonomous mode in step 725.

Alternatively, if it is determined in step 729 that the mode of operation of the vehicle is to change, then process flow proceeds to a step 733 in which the cruise control controls are used to select a non-autonomous mode. In general, a vehicle driver or operator may actuate the cruise control controls to effectuate a change from the autonomous mode to a non-autonomous mode.

After the cruise control controls are used to select a non-autonomous mode, the non-autonomous mode is activated in at step 737, and the vehicle operates in the non-autonomous mode in a step 741. Typically, when the vehicle operates in the non-autonomous mode, the vehicle is driven by a human driver. From step 741, process flow returns to step 713 in which it is determine whether the mode of operation of the vehicle is to switch from the non-autonomous mode to an autonomous mode.

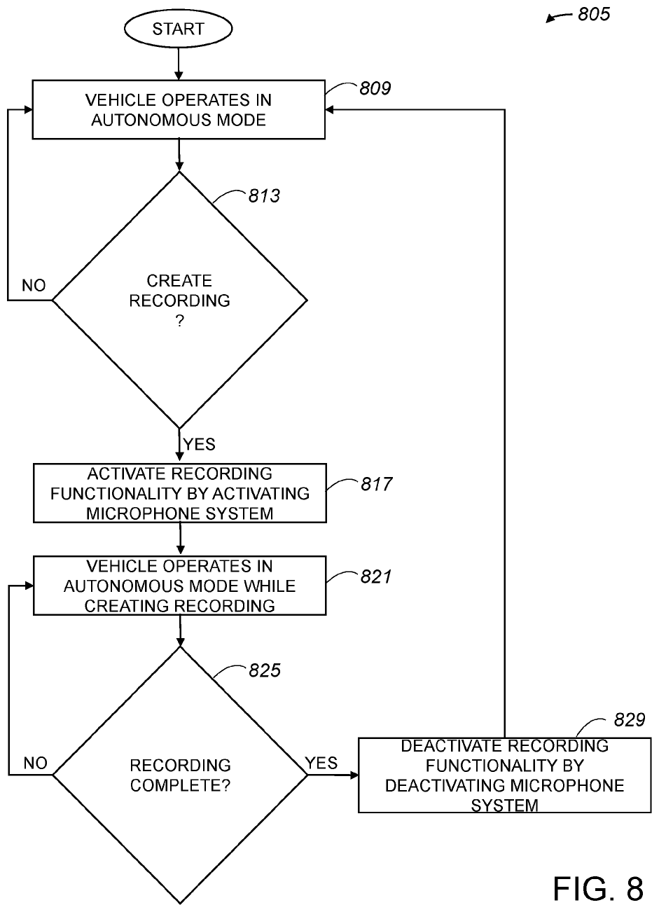

FIG. 8 is a process flow diagram which illustrates one method of operating a recording functionality of a vehicle utilizing microphone controls in accordance with an embodiment. A method 805 for operating a recording functionality begins at a step 809 in which the vehicle operates in autonomous mode. It is determined in a step 813 whether a recording is to be created. Such a determination may involve identifying when a vehicle operator has decided that an audio record relating to the autonomous operation of the vehicle is desired.

If the determination in step 813 is that a recording is not to be created, then process flow returns to step 809 in which the vehicle continues to operate autonomously. Alternatively, if the determination in step 813 is that a recording is to be created, recording functionality is activated in step 817 by activating a microphone system in the vehicle. As previously described, activating a microphone system may include actuating a microphone controller to cause the microphone system to effectively turn on. Actuating the microphone controller may include, but is not limited to including, pressing a button included in the microphone controller to essentially turn the microphone on. In one embodiment, activating the microphone system may substantially automatically cause a recording system to be activated.

In a step 821, the vehicle continues to operate autonomously while the recording is substantially continuously in progress. An operator of the vehicle, or substantially anyone in the vehicle, may speak as the recording is made, e.g., recorded, such that observations of any speakers may effectively be memorialized.

A determination is made in a step 825 as to whether the recording is complete. That is, it is determined whether any more observations are to be recorded. If the determination in step 825 is that the recording is not complete, the vehicle continues to operate in autonomous mode while the recording continues to be created in step 821.

Alternatively, if it is determined in step 825 that the recording is complete, process flow moves to a step 829 in which the recording functionality is deactivated by deactivating the microphone system. Deactivating the microphone system may include actuating a microphone controller, e.g., by pressing a button associated with the microphone controller to turn off the microphone system. From step 829, process flow returns to step 809 in which the vehicle continues to operate in the autonomous mode.

Cruise control controls, e.g., cruise control controls 452 of FIG. 4A. may be configured to enable an autonomous mode for a vehicle to be switched on and off, if discussed above. As cruise control controls often include mechanisms that generally allow for more than an ability to turn cruise control on in a vehicle, more than one mechanism included in cruise control controls may be configured to support an autonomous mode for a vehicle. For example, standard cruise control controls may include multiple control arrangements such as buttons, switches, and the like arranged to turn cruise control on or off, set a speed for cruise control, reset a speed for cruise control, resume cruise control after cruise control has been paused, etc. Some standard cruise control controls may include a lever or a bar that may be actuated into different positions to trigger different functions, e.g., moving a lever to an upward position may cause one function to be activated and moving the lever to a downward position may cause another function to be activated.

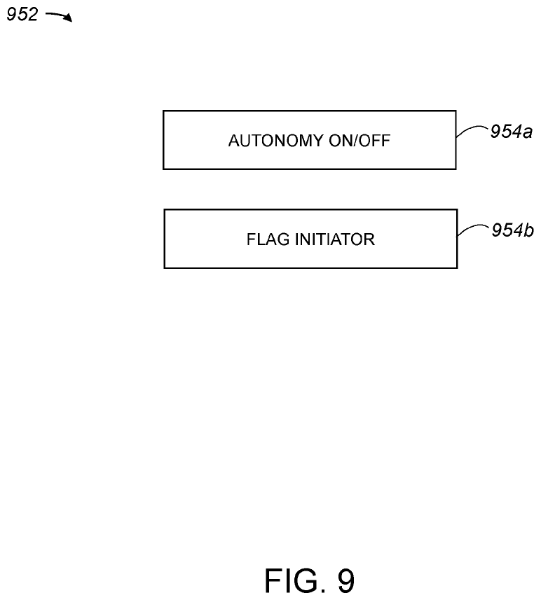

FIG. 9 is a block diagram representation of how multiple control arrangements of cruise control controls may be assigned for use to control an autonomy system in accordance with an embodiment. A cruise control controller 952, which may be configured as any suitable mechanical arrangement, generally includes at least one mechanism 954a, 954b which is effective to initiate a function and/or to terminate the function. In the embodiment as shown, controller 952 includes two mechanisms 954a, 954b, although it should be appreciated that controller 952 is not limited to including two mechanisms 954a, 954b and may include fewer or more mechanisms.

Mechanisms 954a, 954b may be buttons, switches, or any other arrangement which allows mechanisms 954a, 954b to effectively toggle between two or more different states or positions. In other words, mechanisms 954a, 954b may be toggles or mechanical arrangements which are configured to be actuated. For example, a toggle may be an “on/off” toggle which allows a mechanism to effectively move between an “on” position and an “off” position. As will be appreciated by those skilled in the art, buttons and switches may be toggles which have “on” and “off” positions.

First mechanism 954a may be arranged to allow an autonomous mode to be turned on and turned off. When first mechanism 954a is in a first state or position, for example, an autonomy system may be set to allow a vehicle to operate in an autonomous mode. Alternatively, when first mechanism 954a is in a second state or position, the autonomy system may be set to stop the vehicle from operating in an autonomous mode.

Second mechanism 954b may be arranged to allow a flag or an indicator to be added to a log, e.g., an autonomy log, which includes data relating to how a vehicle is operating. By adding a flag to a particular section of a log, a reviewer of the log may be alerted to pay particular attention to the data in that section of the log. For example, second mechanism 954b may be activated or actuated by an operator of a vehicle or a safety driver if an unusual situation is observed. In one embodiment, a first state of second mechanism 954b may correspond to a setting in which a flag is added to a log, and a second state of second mechanism 954b may correspond to a setting in which no flag is added to a log, e.g., the second state may be a default state. As will be appreciated by those skilled in the art, a log may be maintained onboard a vehicle, as for example by an autonomy system, or may be maintained by servers and/or database that are remote from the vehicle.

When a driver or operator in a vehicle that is capable of driving autonomously, or any other vehicle, is concentrating on the road ahead, it may be difficult for the driver to keep track of the state of various systems in the vehicle. For example, a vehicle operator may not always remember that he or she has activated an autonomous mode, or that he or she has initiated an audio recording. As such, a clear visual indication and/or a clear audio indication to the vehicle operator may facilitate his or her understanding of the state of different system within the vehicle.

As will be appreciated by those skilled in the art, buttons and switches may generally be on/off toggles or toggle switches in that each has at least a first position and a second position, or an “on” position and an “off” position. A button, in some embodiments, may be a mechanism configured to send a signal to a switching arrangement to effectively cause the switching arrangement to change states, e.g., from an “on” position to an “off” position.

Many vehicles which have autonomous capabilities include DBW systems which are typically electronic systems which control vehicle operations such as steering, braking, and/or acceleration, or throttling. DBW systems are generally arranged to utilize sensors to obtain information, and to pass the information to a compute system which then converts electrical energy to mechanical motion as appropriate. In one embodiment, a DBW system facilitates the autonomous operation of a vehicle such as vehicle 101 of FIG. 1, vehicle 201 of FIG. 2A, and/or vehicle 211 of FIG. 2B.

In order to keep a vehicle operator, or driver, apprised of the state of a DBW system, a DBW system may include lights, e.g., LED lights, which effectively light up to indicate the state of the DBW system. The lights may be positioned in different locations, and have different colors. Thus, when certain lights light up in certain colors, a particular state may be indicated. For example, one configuration of lights may indicate that autonomous mode is engaged, another configuration of lights may indicate that autonomous mode is ready to be engaged, and another configuration may indicate that a vehicle operator should take over control of the vehicle. Utilizing a combination of lights with different colors and at different locations on a DBW system, i.e., on a DWB PCB or unit, to indicate a status of the DBW system is often ineffective as vehicle operators may not be familiar with what each light indicates. Further, a DBW system is typically hidden from the view of a vehicle operator, as for example in a glove compartment of a vehicle.

By providing a readily accessible DBW notification component unit that is not integrally coupled to a DBW system, a vehicle operator may be able to readily identify the state of the DBW system or, more generally, the state of systems within a vehicle. In one embodiment, a DBW notification component may be a unit that is in wireless or wired communications with a DBW system, e.g., with a PCB of a DBW system, and includes a display screen and a speaker which allows notifications to effectively be viewed and heard. The use of visual notifications on a display screen such as an LCD screen allows information to be presented to a vehicle operator in a clear form. For example, the screen may display “the vehicle is currently ready for autonomous mode” to indicate that the vehicle may be placed into autonomous mode. The use of audible notifications through a speaker allows a vehicle operator to hear information relating to the state of the vehicle, and may be less distracting in some instances than visually displayed information.

A DBW system may be included in a vehicle either to supplement, or to effectively replace, the control of various vehicle operations. In one embodiment, control system 336 may include, or may be in communication with, a DBW system such that the DBW system may provide steering, braking, and/or acceleration, or throttle, controls.

By providing a vehicle operator with substantially real-time information relating to the state of a DBW system in a vehicle, the vehicle operator may more safely operate the vehicle as the vehicle operator will be aware of whether the vehicle is currently in an autonomous mode, in a non-autonomous mode, and/or is in an unexpected state, e.g., is experiencing an error. Providing state information in a readily digestible manner allows a vehicle operator to effectively obtain the information without having to guess as to what lights on a DBW system printed circuit board (PCB), which is typically obscured from the operator. That is, providing state information regarding the DBW system in a readily discernable manner, as for example visually on a display screen and audibly through a speaker, allows a vehicle operator to identify a current state of the DBW system relatively easily.

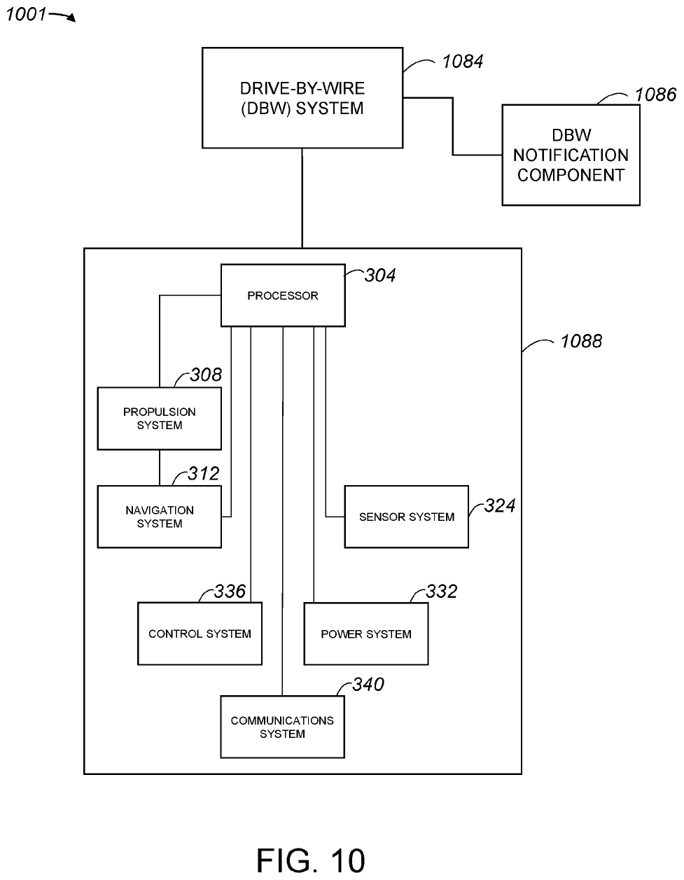

With reference to FIG. 10, a vehicle with a DBW system and a DBW notification component will be described in accordance with an embodiment. A vehicle 1001 includes a DBW system 1084, a DBW notification component 1086, and an overall vehicle platform 1088. DBW system 1084 may generally include software and/or hardware which provide controls, e.g., electronic controls, that enable DBW system 1084 to effectively control operations of vehicle 1001. In the embodiment as shown, DBW system 1084 is in communication with a vehicle platform 1088 that may include at least processor 304, propulsion system 308, navigation system 312, sensor system 324, power system 332, control system 336, and communications system 340. For example, DBW system 1084 may communicate with propulsion system 308 to cause vehicle 1001 to accelerate, brake, and/or steer in a particular direction.

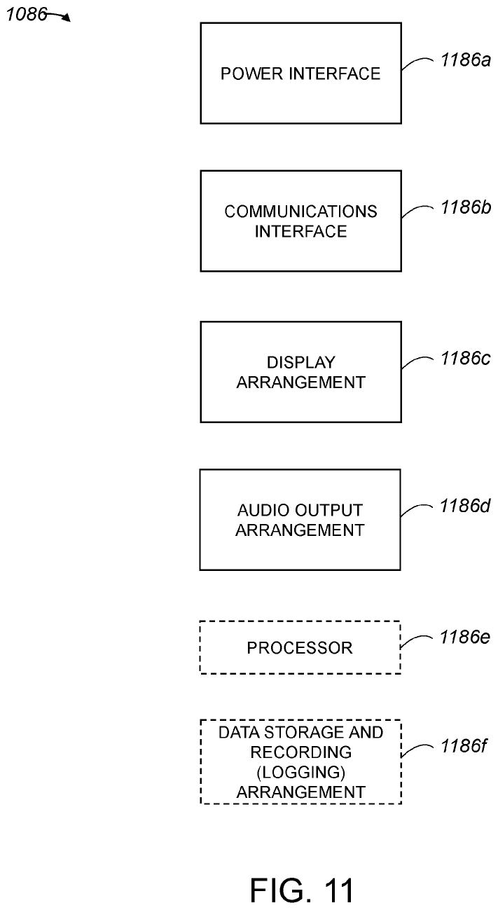

DBW notification component 1086, which will be described in more detail below with respect to FIG. 11, is communicably coupled to DBW system 1084. DBW system 1084 may be substantially separate from DBW notification component 1086, but arranged to communicate wirelessly with DBW notification component 1086. Alternatively, DBW system 1084 may be substantially separate from DBW notification component 1086, but arranged to communicate over a wire, e.g., a bi-directional transmissions line connection, with DBW notification component 1086. In general, DBW notification component 1086 is arranged to obtain or to receive state information from DBW system 1084, and to present the information visually and/or audibly to an operator or driver of vehicle 1001. A visual representation of information may include text, graphics, or pictures which provide an indication of the current state of DBW system 1084. An audible, or audio, representation of information may include a voice, e.g., a voice generated by a voice generator, which provides utterances relating to the current state of DBW system 1084.

The configuration of DBW notification component 1086 may vary widely. Referring next to FIG. 11, one embodiment of a DBW notification component will be described. DBW notification component 1086 includes a power interface 1186a and a communications interface 1186b. Power interface 1186a may be a power supply such as a battery pack, or may be a connection arranged to draw or otherwise obtain power from an external source, e.g., from a vehicle in which DBW notification component 1086 is used. Communications interface 1186b is generally arranged to allow DBW notification component 1086 to communicate with a DBW system, e.g., DBW system 1084 of FIG. 10. Communications interface 1186b may be configured for any suitable wireless communications and/or wired communications. Suitable wireless communications may include, but are not limited to including, Bluetooth communications, Wi-Fi communications, cellular communications such as LTE communications, and 3G/4G/5G communications. Wired communications may include, but are not limited to including, bidirectional wired communications. As will be appreciated by those skilled in the art, communications interface 1186b may generally include a receiver arranged to receive data transmitted wirelessly from a DBW system.

A display arrangement 1186c is configured to provide a visual representation of information or data obtained from a DBW system by DBW notification component 1086. Display arrangement 1186c may be an LCD screen, a touchscreen, or any suitable screen on which information may be displayed. In one embodiment, display arrangement 1186c may be arranged to include a translator or converter which is capable of converting a signal received through communications interface 1186b into a visible representation that may be displayed on a screen of display arrangement 1186c.

An audio output arrangement 1186d is configured to provide an audible representation of information or data obtained from a DBW system by DBW notification component 1086. Audio output arrangement 1186d may include a speaker or any device which may be used to produce sound. In one embodiment, audio output arrangement 1186d may include a voice generator, in addition to a speaker. A voice generator may obtain a signal through communications interface 1186b, may substantially convert or transform the signal into an audible representation that may effectively be broadcasted by a speaker of communications interface 1186d.

DBW notification component 1086 may optionally include a processor 1186e and a data storage and recording arrangement 580. Optional processor 578 may enable DBW notification component to effectively act as a computing device. Optional data storage and recording arrangement 1186f is arranged to provide DBW notification component 1086 with the capability to store information or data obtained from a DBW system. Such stored information or data may then be downloaded, as for example through communications interface 1186d. Optional data storage and recording arrangement 1186f may create, maintain, and/or otherwise contribute to a log which effectively logs information relating to the performance of a vehicle.

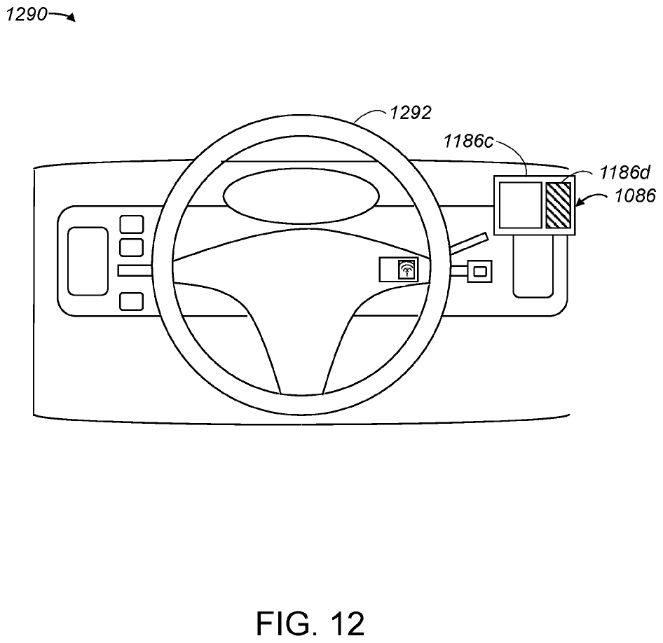

In general, DBW notification component 1086 may be positioned, e.g., installed on or otherwise coupled to, a dashboard of a vehicle such that a vehicle operator of driver may readily access DBW notification component 1086 and, therefore, may readily view DBW notification component 1086. That is, DBW notification component 1086 may be positioned relative to a driver in a vehicle cockpit such that the driver may be able to easily see information displayed using display arrangement 1186c of DBW notification component 1086. FIG. 12 is a diagrammatic representation of a dashboard of a vehicle on which a DBW notification component such as DBW notification component 1086 is installed in accordance with an embodiment. A vehicle dashboard 1290 generally includes a steering wheel 1292 which may be used by an operator to operate a vehicle, i.e., when the vehicle is operating in a non-autonomous or operator-driven mode.

DBW notification component 1086, which includes display 1186c and speaker 1186d, may be installed or otherwise positioned in the vicinity of steering wheel 1292 such that an operator may readily view display 1186c and hear any audio broadcasted through speaker 1186d. DBW notification component 1086 may generally be positioned on or near dashboard 1290 such that an operator may easily access DBW notification component 1086. That is, DBW notification component 1086 is not limited to being positioned as shown in FIG. 12.

Any suitable mechanism (not shown) may be used to install or otherwise couple DBW notification component 1086 on dashboard 1290. Suitable mechanisms may include, but are not limited to including brackets, mounts, fasteners, and the like. In some instances, DBW notification component 1086 may be substantially integrated into dashboard 1290.

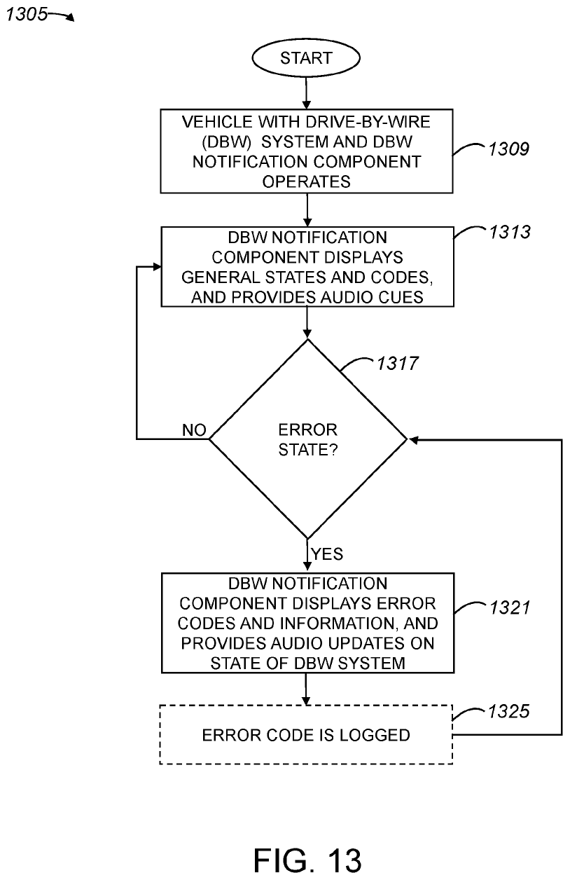

FIG. 13 is a process flow diagram which illustrates a method of operating a DBW notification component in accordance with an embodiment. A method 1305 of operating a DBW notification component such as notification component 1086 of FIG. 10 begins at a step 1309 in which a vehicle with a DBW system and a DBW notification component operates. The vehicle may operate either autonomously or non-autonomously, e.g., under the control of a vehicle operator.

In a step 1313, the DBW component displays general states and codes associated with the DBW system, and provides audio cues or representations of the states and codes. Typically, the current state of the DBW system may be displayed. The general states may include, but are not limited including, an autonomous state, a non-autonomous state, and/or a “ready to be engaged in autonomous mode” state. The codes may include, but are not limited to including, codes which identify the states or modes such as error codes. The audio cues or representations may include cues provide when a state changes, e.g., when the DBW system facilitates a switch from a non-autonomous mode to an autonomous mode, and cues provided periodically to remind an operator of a current state. In one embodiment, when a current state of the DBW system is triggered through the use of cruise control controls to initiate an autonomous mode or state, the display of the current state on the DBW component is effectively triggered to update a display based on signals from the cruise control controls.

A determination is made in a step 1317 as to whether an error state has been detected with respect to the DBW system. If no error state has been detected, then the DBW notification component continues to display general states and codes, and to provide audio cues, in step 1313 Alternatively, if the determination in step 1317 is that an error state has been detected, process flow moves from step 1317 to a step 1321 in which the DBW notification component displays relevant error codes and information, and provides audio updates regarding the state of the DBW system.

Once the DBW notification component displays error codes and information, and provides audio updates, the error code is optionally logged or recorded in a step 1325. As discussed above, logging or recording an error code may facilitate a later analysis to understand the circumstances around which an error occurred. An error code may be logged in a log arranged to detail the state of a vehicle at substantially all times. Such a log may be associated with an autonomy system of a vehicle. After the error code is optionally logged or recorded, process flow returns to step 1313 in which it is determined if an error state is still detected with respect to the DBW system.

Although only a few embodiments have been described in this disclosure, it should be understood that the disclosure may be embodied in many other specific forms without departing from the spirit or the scope of the present disclosure. By way of example, although cruise control controls or mechanisms have been described as suitable for being repurposed for a use relating to autonomous driving, other controls or mechanisms may be repurposed to support autonomous driving. Further, cruise control controls or mechanisms are not limited to being repurposed to support activating and deactivating an autonomous mode.

In one embodiment, cruise control controls may include any number of mechanisms, e.g., buttons or switches, which may allow the cruise control controls to be used for other purposes than to activate and to deactivate an autonomous mode. For instance, in a vehicle with adaptive cruise control capabilities, cruise control controls may include a mechanism that allows a speed to be set and/or a mechanism that allows traffic jam assist capabilities to be set. Such mechanisms may be used by a driver to perform functions such as opening a passenger door and turning on all or part of a compute system of a vehicle without departing from the spirit or the scope of the disclosure. In addition, such mechanisms may also be substantially deactivated such that the mechanisms are not arranged to cause any actions or functions to be activated.

In general, a cruise control system in a vehicle may be substantially permanently deactivated such that cruise control controls may be used to activate and to deactivate an autonomous mode. It should be appreciated that in some embodiments, an additional mechanism may be added to a vehicle that enables a driver to specify whether cruise control controls may allow for cruise control to be engaged, or whether cruise control controls may allow for autonomous mode to be engaged. In other words, in lieu of substantially permanently assigning cruise control controls to be used to trigger autonomous mode, a user may be provided with the capability to determine, before a vehicle is driven, how cruise control controls are assigned.

Pressing a button or engaging a switch on a cruise control stem has been described as substantially automatically causing an autonomous mode of a vehicle to be activated. It should be appreciated, however, that in some embodiments, a vehicle may be configured such that when a sensor system in cooperation with autonomy software determines that it may not be prudent to engage the autonomous mode, pressing the button or engaging the switch may not engage autonomous mode. For example, pressing a button or engaging a switch may effectively trigger a determination of whether engaging autonomous mode is safe, and may subsequently cause autonomous mode to be engaged if the determination is that engaging autonomous mode is safe. In one embodiment, there may be a brief delay, e.g., a few seconds, between using cruise control controls to attempt to activate an autonomous mode and actually activating the autonomous mode. The brief delay may allow a determination to be made as to whether autonomous mode may be safely engaged.

In one embodiment, a cruise control controls may be used to initiate and to terminate recording functions intended to allows activities within a vehicle to be recorded, e.g., such that an operator or safety driver may provide audio commentary relating to the autonomous operation of a vehicle. That is, a button or switch on a cruise control stem may be substantially assigned to trigger a microphone such as a microphone included in microphone system 574 of FIG. 6A.

A microphone system may be arranged to communicate with a driver compute system of a vehicle. When a microphone system is arranged to communicate with a driver compute system, the microphone system may either be substantially directly connected to the driver compute system, or the microphone system may effectively be connected to the driver compute system through a DBW system.

The configuration of a DBW notification component may vary widely. While a DBW notification component may include both a display screen and a speaker, it should be appreciated that a DBW notification component may instead include either just a display screen or just a speaker. For an embodiment in which the DBW notification component does not include a speaker, the DBW notification component may include circuitry and/or mechanisms which allow DBW notification component to substantially connect to a speaker system in a vehicle such that the speaker system may effectively be used the DBW notification to provide audible notifications.

In one embodiment, a DBW notification component may be removably coupled to a vehicle. That is, the DBW notification component may be relatively portable. Alternatively, a DBW notification component may be substantially hard-wired into a vehicle without departing from the spirit or the scope of the disclosure.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. For example, the steps associated with operating a vehicle in which cruise control controls are used to activate and to deactivate an autonomous mode may include determining whether the vehicle has come to a stop. In one embodiment, when a vehicle has come to a stop, a “resume” functionality associated with cruise control controls may be used to put the vehicle back into the mode the vehicle was in prior to the stop. Additionally, each of the methods above may effectively end, or be terminated prematurely, in the event that the vehicle comes to a stop either under the control of a human driver or due to actions taken when the vehicle is operating autonomously.

Therefore, the present examples are to be considered as illustrative and not restrictive, and the examples are not to be limited to the details given herein, but may be modified within the scope of the appended claims.

What is claimed is:

1. A vehicle comprising:
an autonomy system, the autonomy system configured to enable the vehicle to operate in an autonomous mode when the autonomy system is in an active state;
an activator mechanism, the activator mechanism including a toggle, the toggle having a first toggle state and a second toggle state, the toggle being in communication with the autonomy system to activate the active state when the toggle is in the first toggle state and to deactivate the active state when the toggle is in the second toggle state; and
a cruise control system, the cruise control system arranged to be engaged to cause a speed of the vehicle to be automatically controlled, wherein the cruise control system is physically decoupled from the activator mechanism.

2. The vehicle of claim 1 wherein the cruise control system is in communication with the autonomy system, and wherein the autonomy system includes a propulsion system that is configured to cause the vehicle to drive.

3. The vehicle of claim 2 wherein the cruise control system is configured to control the propulsion system to cause the vehicle to drive, wherein the autonomy system causes the cruise control system to control the propulsion system.

4. The vehicle of claim 1 further including:
a first interface system, the first interface system being communicably coupled to the autonomy system and to the activator mechanism, the first interface system further being coupled to the cruise control system, wherein the first interface system is configured to cause a signal from the activator mechanism to be obtained by the autonomy system.

5. The vehicle of claim 4 wherein the first interface system is further configured to prevent the signal from the activator mechanism from being obtained by the cruise control system.

6. The vehicle of claim 5 wherein the first interface system is configured to communicably couple the autonomous vehicle system and the cruise control system.

7. The vehicle of claim 1 further including:
a microphone system, wherein the autonomous vehicle system includes a recording system, the recording system being arranged to record audio captured by the microphone system.

8. The vehicle of claim 7 further including:
a microphone controller, the microphone controller arranged to be activated to activate the microphone system, wherein the microphone controller is further arranged to activate the recording system to record the audio captured by the microphone system.

9. The vehicle of claim 1 wherein the activator mechanism further includes an actuating mechanism, the actuating mechanism configured to cause an indicator to be added to a log associated with the autonomy system.

10. The vehicle of claim 1 wherein the toggle is a switch.

11. The vehicle of claim 1 wherein the toggle is a button.

12. A method of controlling a vehicle, the vehicle having at least a first mode of operation and a second mode of operation, the method comprising:
operating the vehicle in the first mode of operation;
determining when a mode change is indicated using a toggle of an activator mechanism, wherein determining when the mode change is indicated using the toggle includes obtaining a first signal at an autonomy system of the vehicle from the activator mechanism through an interface, the interface configured to communicably connect the activator mechanism to the autonomy system and to disconnect the activator mechanism from a cruise control system of the vehicle; and
when the mode change is indicated, operating the vehicle in the second mode of operation using the autonomy system.

13. The method of claim 11 wherein the autonomy system communicates with the cruise control system using the interface, and wherein the autonomy system includes a propulsion system that is configured to cause the vehicle to operate.

14. The method of claim 12 wherein the cruise control system is configured to control the propulsion system to cause the vehicle to operate, wherein the autonomy system causes the cruise control system to control the propulsion system.

15. The method of claim 11 wherein the first mode of operation is a non-autonomous mode of operation, and wherein the second mode of operation is an autonomous mode of operation.

16. The method of claim 11 wherein the interface is configured to disconnect the activator mechanism from the cruise control system by preventing the first signal from being provided to the cruise control system.

17. The method of claim 11 further including:
determining when a recording system of the autonomy system is to be activated to record audio, wherein determining when the recording system of the autonomy system is to be activated to record the audio includes determining when a second signal is obtained by a microphone controller of the vehicle from a mechanism included in the activator mechanism, the microphone controller being communicably coupled to the autonomy system through a microphone system.

18. The method of claim 17 wherein when it is determined that the recording system of the autonomy system is to be activated to record the audio, the method further includes:
activating the recording system;
recording the audio using the microphone system and the recording system,

19. The method of claim 11 wherein the activator mechanism further includes an actuating mechanism, the actuating mechanism configured to cause an indicator to be added to a log associated with the autonomy system, and wherein the method further includes:
creating the log, the log being arranged to indicate at least one status of the vehicle;
determining when the actuating mechanism indicates that the indicator is to be added to the log; and
adding the indicator to the log.

20. The method of claim 11 wherein the toggle is a switch.

21. The method of claim 11 wherein the toggle is a button.
